(19) United States
(12) Patent Application Publication
(10) Pub. No.: US 2018/0029565 A1
(43) Pub. Date: Feb. 1, 2018

(54) WINDSHIELD WIPER LIFTER

(71) Applicant: 1950734 ALBERTA LTD, Edmonton (CA)

(72) Inventor: Michael Rufus Goldie Williams, Edmonton (CA)

(73) Assignee: 1950734 ALBERTA LTD, Edmonton (CA)

(21) Appl. No.: 15/224,703

(22) Filed: Aug. 1, 2016

(51) Int. Cl. B60S 1/34

(52) U.S. Cl. CPC B60S 1/3422

(57) ABSTRACT

A windshield wiper lifter includes a bar, a first clip and a second clip. The first clip can be coupled to the bar and can be configured to engage a first windshield wiper arm. The second clip can be coupled to the bar and can be configured to connect to a second windshield wiper arm spaced from the first windshield wiper arm.

### BACKGROUND

### 1. Field

The present disclosure relates to a windshield wiper lifter.

### 2. Description of Related Prior Art

U.S. Pat. No. 8,365,345 discloses a windshield wiper lifter. The windshield wiper lifter mounts to a standard vehicle windshield wiper arm. The windshield wiper lifter has an articulating arm affixed approximately perpendicular to the windshield wiper. A first block and a second block are affixed to the windshield in the arced path of the windshield wiper lifter. When the windshield wiper lifter strikes the first block it raises the wiper arm off of the windshield when the wiper arm strokes in a first direction. When the windshield wiper lifter strikes the second block it lowers the windshield wiper arm when stroking in a second direction.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A windshield wiper lifter includes a bar, a first clip and a second clip. The first clip can be coupled to the bar and can be configured to engage a first windshield wiper arm. The second clip can be coupled to the bar and can be configured to connect to a second windshield wiper arm spaced from the first windshield wiper arm.

### BRIEF DESCRIPTION OF THE DRAWINGS

The detailed description set forth below references the following drawings:

FIG. 1 is a front view of a windshield, first and second windshield wiper arms, and an exemplary embodiment of the present disclosure;

FIG. 2 is a cross-sectional view through section lines 2-2 in FIG. 1;

FIG. 3 is a cross-sectional view through section lines 3-3 in FIG. 1;

FIG. 4 is a cross-sectional view through section lines 4-4 in FIG. 1;

FIG. 5 is a cross-sectional view through section lines 5-5 in FIG. 1; and

FIG. 6 is a perspective view of an end of the exemplary embodiment.

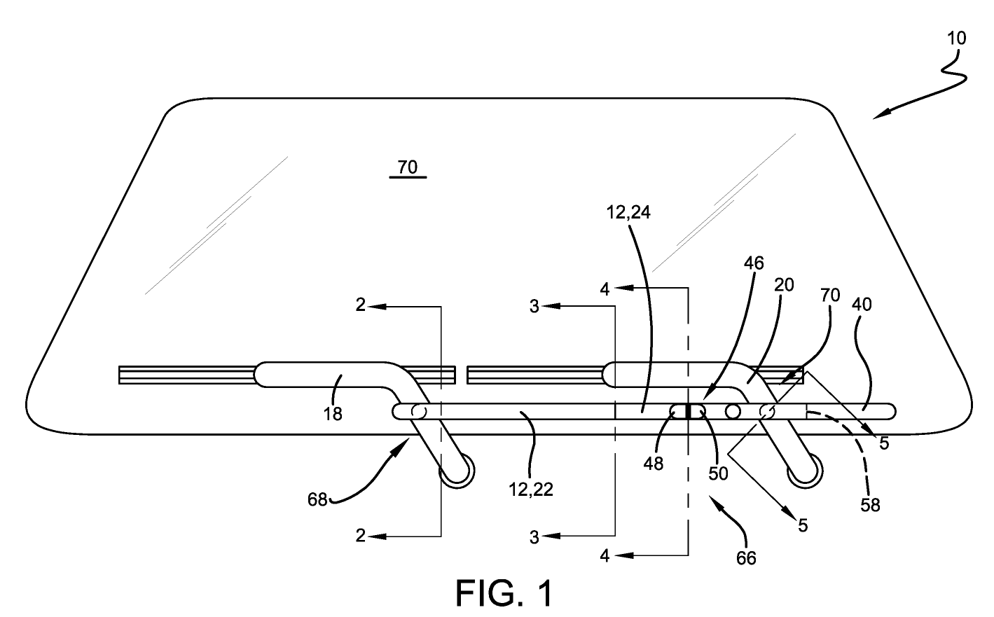

### DETAILED DESCRIPTION

A windshield wiper lifter 10 includes a bar 12, a first clip 14 and a second clip 16. The first clip 14 can be coupled to the bar 12 and can be configured to engage a first windshield wiper arm 18. The second clip 16 can be coupled to the bar 12 and can be configured to connect to a second windshield wiper arm 20 spaced from the first windshield wiper arm 18.

The exemplary bar 12 can include a first member 22 and second member 24. The exemplary first member 22 can have a polygonal cross-section, but can be differently shaped in other embodiments of the present disclosure. The exemplary second member 24 can have a polygonal cross-section, but can be differently shaped in other embodiments of the present disclosure. The first member 22 and the second member 24 can be telescopically engaged with one another.

The first clip 14 and the second clip 16 can be substantially the same or different in various embodiments of the present disclosure. The exemplary first clip 14 and the exemplary second clip 16 are identical in the exemplary embodiment of the present disclosure. Each of the clips 14, 16 can be pivotally coupled to the bar 12 such that each of the first clip 14 and the second clip 16 can rotate relative to the bar 12 while coupled to the bar 12. As shown in FIG. 5, a pin 26 can interconnect a body 28 of the second clip 28 to the second member 24 of the bar 12. The pin 26 allows the body 28 to freely rotate relative to the second member 24.

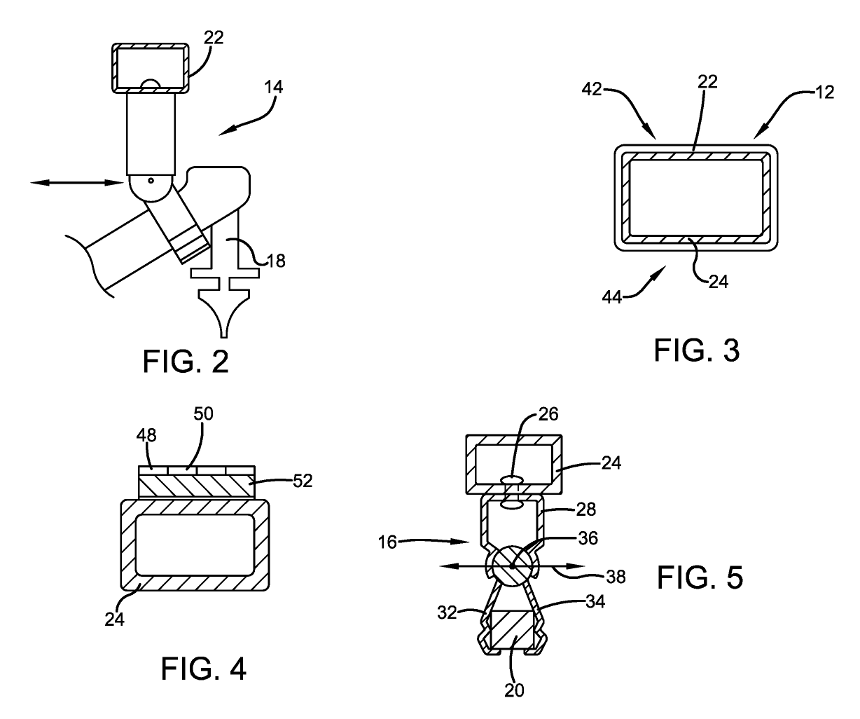

Each of clips 14, 16 can include a roller ball mounted in the body. The second clip 16 includes a roller ball 30 mounted in the body 28. The body 28 captures the roller ball 30 wherein the roller ball 30 is prevented from escaping out of the body 28, but is also free to rotate about its center. First and second prongs 32, 34 are fixedly mounted to the roller ball 30. As shown in FIG. 5, the first and second prongs 32, 34 can be mirrored with respect to one another across a plane passing through the center of the roller ball 30. It is noted that In FIG. 5 the first and second prongs 32, 34 are extending straight down while in FIG. 2 the first and second prongs of the first clip 14 are extending transverse to the straight down direction.

The roller ball 30 and first and second prongs 32, 34 define a portion of the second clip 16 that can rotate relative to the bar 12 while coupled to the bar 12 about at least two axes that are perpendicular to one another. In FIG. 5, a first axis is referenced at 36 and extends out of the page and into the page. The roller ball 30 can rotate the first and second prongs 32, 34 out of the page and into the page. A second axis is referenced at 38 and extends across the page. The roller ball 30 can rotate the first and second prongs 32, 34 side-to-side, across the page.

The exemplary windshield wiper lifter 10 can also include a handle 40 pivotally connected with the bar 12. The handle 40 can be connected to a top side 42 of the bar 12. The first clip 14 and the second clip 16 can be coupled to a bottom side 44 of the bar 12 opposite to the top side 42. The handle 40 can be connected to the bar 12 with hinge assembly 46. The hinge assembly 46 can include a plate 48 fixed to the bar, a plate 50 fixed the handle 40, and pin 52 passing through an aperture defined by the plates 48, 50.

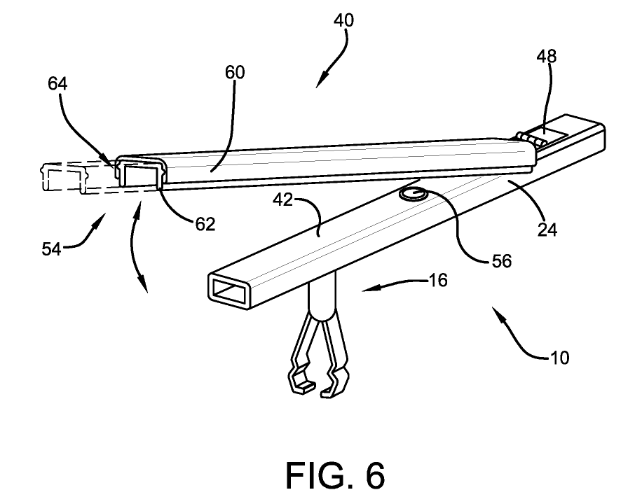

As best shown in FIG. 6, a bottom side 54 of the handle 40 can be shaped to confirm to the top side 42 of the bar 12. The bottom side 54 of the handle 40 can overlap the top side 42 of the bar 12 and can be flush with the top side 42. The windshield wiper lifter 10 can also include a magnet 56 operably positioned to releasibly lock the handle 40 and the bar 12 together. The magnet 56 can generate a magnetic field strong enough to retain the handle 40 the top side 42. The handle 40 can project past an edge 58 of the bar 12, allowing the handle 40 to be easily grasped and pivoted away from the top side 42 and the magnet 56.

The exemplary handle 40 can be telescopic, similar to the bar 12. The exemplary handle 40 can include a first link 60 pivotally connected with the bar 12 through the hinge assembly 46 and a second link 62 telescopically engaged with the first link 60. The first and second links 60, 62 can be connected through a tongue and groove arrangement, as referenced at 64 in FIG. 6.

The handle 40 is connected with the bar 12 at a first position 66 along a length of the bar 12 (the plane of FIG. 4), the first clip 14 is connected with the bar 12 at a second position 68 along the length, and the second clip 16 is connected with the bar 12 at a third position 70 along the length (the plane of FIG. 5). The first position 66 is between the second position 68 and the third position 70.

In a method of using the windshield wiper lifter 10, the first clip 14 can be engaged to the first windshield wiper arm 18. Next, the second clip 16 can be connected to the second windshield wiper arm 20. In connecting, the second clip 16 to the arm 16, the bodies of the clips 14, 16 can be rotated as desired, the roller balls of the clips 14, 16 can be rotated as desired, and the bar 12 can be telescopically extended or retracted as desired. The bar 12 thereby interconnects the first windshield wiper arm 18 and the second windshield wiper arm 20. When it is desired to lift both arms 18, 20 concurrently, the user can grasp the handle 40 and pull both arms 18, 20 away from a windshield 70.

The windshield wiper lifter 10 can remain on the first windshield wiper arm 18 and the second windshield wiper arm 20 as the vehicle is used, in contrast to be mounted on the arms 18, 20 only when it is desired to lift the arms 18, 20. Movement of the first windshield wiper arm 18 and the second windshield wiper arm 20 can be accommodated without resistance from the windshield wiper lifter 10 through several features. First, the first member 22 and the second member 24 can be telescopically engaged with one another and can slide freely relative to one another. Second, the clips 14, 16 are able to freely rotate relative the bar 12. Third, prongs of each of the clips 14, 16 are able to freely pivot about multiple axes.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A windshield wiper lifter comprising:
a bar;
a first clip coupled to said bar and configured to engage a first windshield wiper arm; and
a second clip coupled to said bar and configured to connect to a second windshield wiper arm spaced from said first windshield wiper arm.

2. The windshield wiper lifter of claim 1 further comprising
a handle pivotally connected with said bar.

3. The windshield wiper lifter of claim 2 wherein said handle is connected to a top side of said bar and said first clip and said second clip are coupled to a bottom side of said bar opposite to said top side.

4. The windshield wiper lifter of claim 2 further comprising:
a magnet operably positioned to releasibly lock said handle and said bar together.

5. The windshield wiper lifter of claim 2 wherein said handle further comprises:
a first link pivotally connected with said bar; and
a second link telescopically engaged with said first link.

6. The windshield wiper lifter of claim 2 wherein said handle is connected with said bar at a first position along a length of said bar, said first clip is connected with said bar at a second position along said length, said second clip is connected with said bar at a third position along said length, and said first position is between said second position and said third position.

7. The windshield wiper lifter of claim 1 wherein said first clip and said second clip are further defined as pivotally coupled to said bar such that each of said first clip and said second clip can rotate relative to said bar while coupled to said bar.

8. The windshield wiper lifter of claim 7 wherein said first clip and said second clip are further defined as pivotally coupled to said bar such that at least a portion of each of said first clip and said second clip can rotate relative to said bar while coupled to said bar about at least two axes that are perpendicular to one another.

9. The windshield wiper lifter of claim 1 wherein said bar further comprises:
a first member; and
a second member telescopically engaged with said first member.

10. A windshield wiper lifter comprising:
a bar having a first member and a second member telescopically engaged with said first member;
a first clip pivotally coupled to said first member of said bar and configured to engage a first windshield wiper arm;
a second clip pivotally coupled to said second member of said bar and configured to connect a second windshield wiper arm spaced from said first windshield wiper arm; and
a handle pivotally connected with said bar.

11. A method of using the windshield wiper lifter of claim 1 comprising:
engaging the bar to the first windshield wiper arm with the first clip; and
connecting the bar to the second windshield wiper arm spaced from said first windshield wiper arm with the second clip, wherein the first clip is engaged with the first windshield wiper arm while the second clip is connected to the second windshield wiper arm and the bar thereby interconnects the first windshield wiper arm and the second windshield wiper arm.
